(19) United States
(12) Patent Application Publication
(10) Pub. No.: US 2008/0025197 A1
(43) Pub. Date: Jan. 31, 2008

(54) ESTIMATING FREQUENCY ERROR OF A SAMPLE STREAM

(76) Inventor: James W. McCoy, Austin, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/460,847

(22) Filed: Jul. 28, 2006

(51) Int. Cl. H04J 11/00

(52) U.S. Cl. 370/208

(57) ABSTRACT

A method for estimating a frequency error of a sample stream comprising a plurality of symbols is provided. The method may include receiving the sample stream. The method may further include estimating a frequency error from a phase distribution or a linear function of the phase distribution of an autocorrelation generated by autocorrelating a cyclic prefix of each of the plurality of symbols with a corresponding information part of each of the plurality of symbols over at least two frequencies to generate the phase distribution of the autocorrelation.

### FIELD OF THE INVENTION

The present invention relates generally to communication methods and systems, and more particularly to estimating frequency error of a sample stream.

### RELATED ART

Traditionally, initial fine frequency acquisition of a sample stream, such as an orthogonal frequency division multiplexed (OFDM) signal, has been accomplished using techniques that ignore the delay spread. Delay spread is typically introduced when the same signal is received via different paths resulting in different time delay. Ignoring the delay spread in the initial fine frequency acquisition, however, results in poor initial fine frequency acquisition in delay spread environments.

Thus, there is a need for methods and systems for estimating frequency error of a sample stream.

### BRIEF DESCRIPTION OF THE DRAWINGS

The present invention is illustrated by way of example and not limited by the accompanying figures, in which like references indicate similar elements, and in which:

FIG. 1 is a block diagram of an exemplary OFDM receiver, consistent with one embodiment of the invention;

FIG. 2 is a diagram illustrating an exemplary multi-carrier symbol stream 20, consistent with one embodiment of the invention;

FIG. 3 is a flow chart for an exemplary method for estimating a frequency error from a phase distribution, consistent with one embodiment of the invention;

FIG. 4 is a flow chart for an exemplary method for estimating a frequency error based on at least one characteristic of a histogram, consistent with one embodiment of the invention; and

FIG. 5 is a flow chart for an exemplary method for estimating a frequency error, consistent with one embodiment of the invention.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION OF THE EMBODIMENTS

Consistent with embodiments of the invention, methods and systems for estimating a frequency error of a sample stream are provided. By way of example, blind orthogonal frequency division multiplexing (OFDMA) synchronization algorithms based on cyclic correlation that employ frequency diversity are provided. The exemplary methods break the autorcorrelation computation into frequency bins and then average the result to produce a final frequency error estimate, such as a frequency offset estimate. Although the following description relates to an OFDM signal, which is a multi-carrier signal, the disclosed methods and systems may also be used in single-carrier systems.

The disclosed embodiments may be used as part of initial acquisition of a frequency of an OFDMA signal. Frequency acquisition may be achieved in two steps: coarse acquisition and fine acquisition. The disclosed embodiments relate to the fine acquisition part of the frequency acquisition, such that the frequency accuracy produced by the coarse acquisition is adequate to perform fine acquisition. The signal output as a result of the processing by the disclosed methods and systems may be decoded and further processed. The fine acquisition algorithms may be performed prior to frames comprising the symbols of the sample stream are decoded.

In one aspect, a method for estimating a frequency error of a sample stream comprising a plurality of symbols is provided. The method may include receiving the sample stream. The method may further include estimating a frequency error from a phase distribution or a linear function of the phase distribution of an autocorrelation generated by autocorrelating a cyclic prefix of each of the plurality of symbols with a corresponding information part of each of the plurality of symbols over at least two frequencies to generate the phase distribution of the autocorrelation.

In another aspect, a method for estimating a frequency error of a sample stream comprising a plurality of symbols is provided. The method may include receiving the sample stream. The method may further include simultaneously autocorrelating a cyclic prefix of each of the plurality of symbols with a corresponding portion of an information part of each of the plurality of symbols over at least two frequencies to generate a phase distribution of the autocorrelation. The method may further include generating a histogram of the phase distribution. The method may further include estimating the frequency error based on at least one characteristic of the histogram.

In yet another aspect, a method for estimating a frequency error of a sample stream comprising a plurality of symbols is provided. The method may include receiving the sample stream. The method may include simultaneously autocorrelating a cyclic prefix of each of the plurality of symbols with a corresponding portion of an information part of each of the plurality of symbols over at least two frequencies to generate a phase distribution of the autocorrelation. The method may further include generating a histogram of the phase distribution. The method may further include generating a first estimate of at least one characteristic of the histogram. The method may further include generating a second estimate of the at least one characteristic of the histogram. The method may further include estimating the frequency error based on the second estimate.

FIG. 1 is an exemplary block diagram of a receiver for processing a received sample stream, such as an orthogonal frequency division multiplexed sample stream. By way of example, an OFDM receiver 10 may include, among other components, an OFDM engine 12 and a RF/mixed signal processor 16. By way of example, RF/mixed signal processor 16 may receive a RF signal 14 via an antenna. RF/mixed signal processor 16 may generate a sample stream 18, which may be an OFDM complex valued sample stream. OFDM engine 12 may capture sample stream 18 and process it further in accordance with the embodiments of the invention. OFDM engine may sample the complex valued sample stream based on a frequency (fₛ, for example) of the sample clock synthesized from a local oscillator (not shown) incorporated in the OFDM receiver of FIG. 1, for example. OFDM receiver 10 may be implemented using any combination of hardware, software, and/or firmware. Although FIG. 1 shows only an OFDM engine 12 and a RF/mixed signal processor 16 as part of OFDM receiver 10, the OFDM receiver may include additional or fewer components.

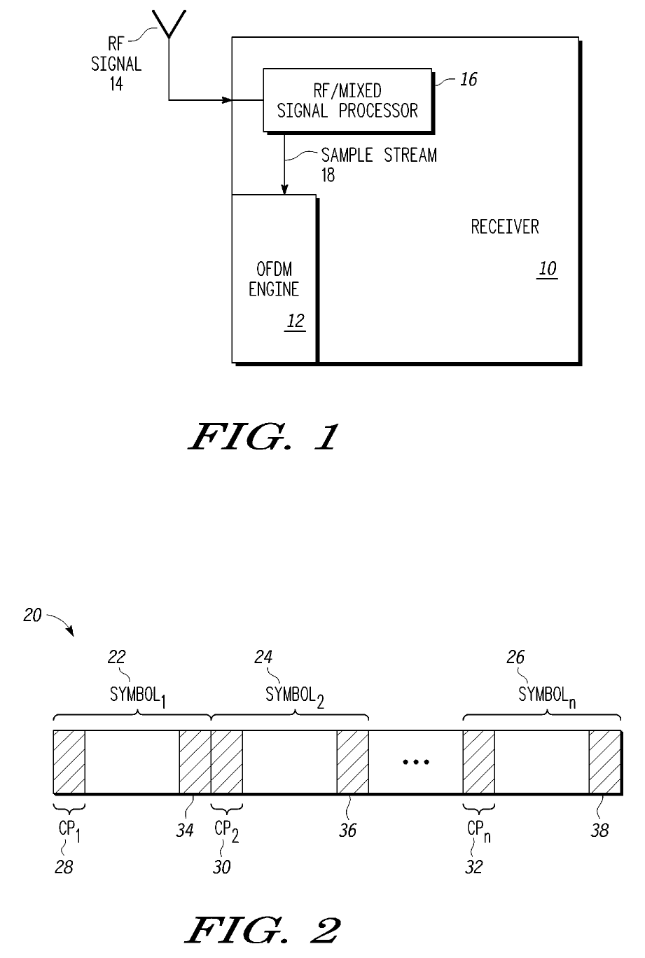

FIG. 2 is a diagram illustrating an exemplary symbol stream 20, consistent with one embodiment of the invention. Symbol stream 20 may include symbols: SYMBOL₁ 22, SYMBOL₂ 24, and SYMBOLₙ 26. Each symbol may comprise a cyclic prefix and an information portion. For example, symbol 22 may include a cyclic prefix CP₁ 28, symbol 24 may include a cyclic prefix CP₂ 30, and symbol 26 may include a cyclic prefix CPₙ 32. The information portion of each symbol may include information, which may have further information parts, such as 34, 36, and 38, respectively.

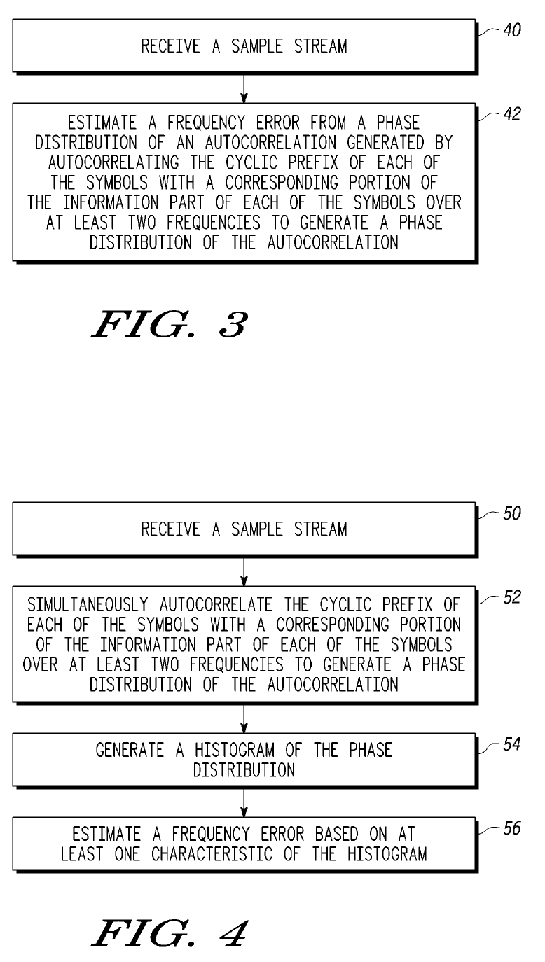

FIG. 3 is a flow chart for an exemplary method for estimating a frequency error from a phase distribution, consistent with one embodiment of the invention. As part of this method, first a sample stream (for example, 20 of FIG. 2) may be received using a receiver (step 40), such as receiver 10, shown in FIG. 1. The method may further include estimating a frequency error from a phase distribution or a linear function of the phase distribution of an autocorrelation generated by autocorrelating a cyclic prefix of each of the plurality of symbols with a corresponding information part of each of the plurality of symbols over at least two frequencies to generate the phase distribution of the autocorrelation (step 42). As part of this step, a frequency diversity based autocorrelation may be computed. By way of example, the following equation may be used to calculate the frequency diversity based autocorrelation:

$$\begin{matrix}{R}_{rr} ( k , {N}_{fft} ) = {\sum }_{Δ = - CP + 1}^{CP - 1} ( CP - abs ( Δ ) {e}^{- {j}^{2 πΔ k / {N}_{fft}}} \\ {\sum }_{{n}^{′} = max ( 1 , - Δ + 1 )}^{min ( CP , CP - Δ )} r ( {n}^{′} ) r * ( {n}^{′} + Δ + {N}_{fft} ) )\end{matrix}$$

where, CP is the cyclic prefix;

N_{fft} is equal to T_{fft}*fₛ, and where f_{Δ} is the frequency spacing between the OFDM sub-carriers, T_{fft} is approximately 1/f_{Δ}, and fₛ is the sampling rate of the OFDM complex valued sample stream;

Δ is the incremental delay relative to N_{fft};

k is a frequency index of the autocorrelation function; and

n′ is a time index of the complex valued sample stream.

Thus, the estimation of frequency error may be viewed as a two-stage process: (1) estimate an autocorrelation at various delays (using Equation 1, for example); and (2) compute a fast fourier transform (FFT) of the computed autocorrelation at various delays. Although the above equation uses certain constant values, these values may be different for different OFDM applications, such as Digital Audio Broadcasting, Digital Video Broadcasting, Integrated Services Digital Broadcasting, Wireless LAN (IEEE 802.11(a/g), HiperLAN/2, MMAC), Wireless MAN, and IEEE 802.20, or other OFDM applications, standards, and/or platforms. The above example corresponds to the IEEE 802.16(e) standard.

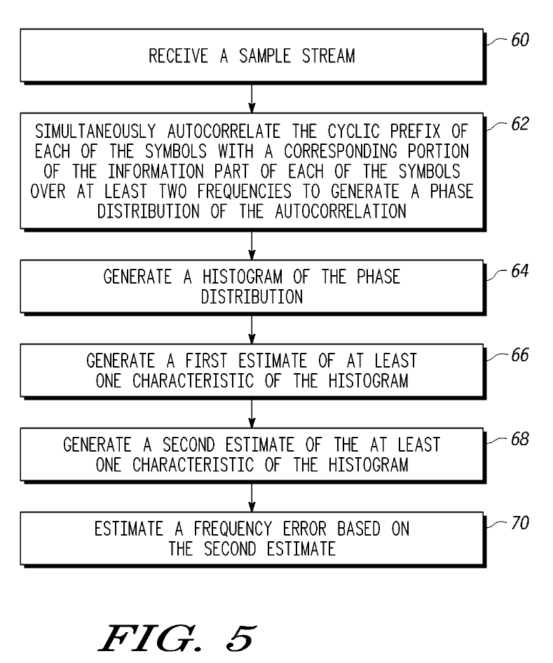

FIG. 4 is a flow chart for an exemplary method for estimating a frequency error based on at least one characteristic of a histogram, consistent with one embodiment of the invention. As part of this method, first a sample stream (for example, 20 of FIG. 2) may be received using a receiver (step 50), such as receiver 10, shown in FIG. 1. The method may further include simultaneously autocorrelating a cyclic prefix of each of the plurality of symbols with a corresponding portion of an information part of each of the plurality of symbols over at least two frequencies to generate a phase distribution of the autocorrelation (step 52). As part of this step, a frequency diversity based autocorrelation may be computed. By way of example, the following equation may be used to calculate the frequency diversity based autocorrelation:

$$\begin{matrix}{R}_{rr} ( k , {N}_{fft} ) = {\sum }_{Δ = - CP + 1}^{CP - 1} ( CP - abs ( Δ ) {e}^{- {j}^{2 πΔ k / {N}_{fft}}} \\ {\sum }_{{n}^{′} = max ( 1 , - Δ + 1 )}^{min ( CP , CP - Δ )} r ( {n}^{′} ) r * ( {n}^{′} + Δ + {N}_{fft} ) )\end{matrix}$$

where, CP is the cyclic prefix;

N_{fft} is equal to T_{fft}*fₛ, and where f_{Δ} is the frequency spacing between the OFDM sub-carriers, T_{fft} is approximately 1/f_{Δ}, and fₛ is the sampling rate of the OFDM complex valued sample stream (thus N_{fft} is the size of the fast fourier transform for the OFDM complex valued sample stream;

Δ is the incremental delay relative to N_{fft};

k is a frequency index of the autocorrelation function; and

n′ is a time index of the complex valued sample stream.

Thus, the estimation of frequency error may be viewed as a two-stage process: (1) estimate the autocorrelation at various delays; and (2) compute a fast fourier transform of the computed autocorrelation at various delays. Although the above equation uses certain constant values, these values may be different for different OFDM applications, such as Digital Audio Broadcasting, Digital Video Broadcasting, Integrated Services Digital Broadcasting, Wireless LAN (IEEE 802.11(a/g), HiperLAN/2, MMAC), Wireless MAN, and IEEE 802.20, or other OFDM applications, standards, and/or platforms. The above example corresponds to the IEEE 802.16(e) standard.

The method may further include generating a histogram of the phase distribution (step 54). By way of example, as part of this step, a histogram of the phase distribution of the previously computed autocorrelation may be generated. By way of example, the histogram may be generated using the following equation:

f(b(n))=hist(∠Rᵣᵣ(k, Nfft))

where f(b(n)) is the histogram of the angle of the autocorrelation; and

b(n) are the bin centers of the histogram of the autocorrelation.

The method may further include estimating the frequency error based on at least one characteristic of the histogram (step 56). By way of example, at least one characteristic of the histogram may relate to a mean, mode, or a mean over a subset of bin centers. By way of example, an estimate of an at least one characteristic, for example, an estimate of a mean of the histogram may be computed using the following equation:

$$Estimateofmean = \frac{{\sum }_{n = 0}^{n = N - 1} b ( n ) f ( b ( n ) )}{{\sum }_{n} f ( b ( n ) )}$$

where f(b(n)) is the histogram of the angle of the autocorrelation; and

b(n) are the bin centers of the histogram of the autocorrelation.

The frequency error may be computed by computing an estimated frequency from the estimated mean or mode of the histogram by using the following equation:

fₑₛₜ=fₛ*(estimate of a characteristic of the histogram)/(2π*N_{fft}),

where fₑₛₜ is the final frequency estimate;

fₛ is the sampling rate of the OFDM complex valued sample stream;

estimate of a characteristic of the histogram may be an estimate of the mean or mode of the histogram; and

N_{fft} is equal to T_{fft}*fₛ, and where f_{Δ} is the frequency spacing between the OFDM sub-carriers, T_{fft} is approximately 1/f_{Δ}, and fₛ is the sampling rate of the OFDM complex valued sample stream (thus N_{fft} is the size of the fast fourier transform for the OFDM complex valued sample stream).

FIG. 5 is a flow chart for an exemplary method for estimating a frequency error, consistent with one embodiment of the invention. As part of this method, first a sample stream (for example, 20 of FIG. 2) may be received using a receiver (step 60), such as receiver 10, shown in FIG. 1. The method may further include simultaneously autocorrelating a cyclic prefix of each of the plurality of symbols with a corresponding portion of an information part of each of the plurality of symbols over at least two frequencies to generate a phase distribution of the autocorrelation (step 62). As part of this step, a frequency diversity based autocorrelation may be computed. By way of example, the Equation 1, as discussed above with respect to FIG. 4 may be used to calculate the frequency diversity based autocorrelation:

The method may further include generating a histogram of the phase distribution (step 64). By way of example, as part of this step, a histogram of the phase distribution of the previously computed autocorrelation may be generated. By way of example, the histogram may be generated using the following equation:

f(b(n))=hist(∠Rᵣᵣ(k, Nfft))

where f(b(n)) is the histogram of the angle of the autocorrelation; and
b(n) are the bin centers of the histogram of the autocorrelation.

Next, as part of step 66, a first estimate of at least one characteristic of the histogram may be generated. By way of example, a first estimate (for example, an initial estimate) may be computed using the following equation:

$$InitialEstimate = \frac{{\sum }_{n = 0}^{n = N - 1} b ( n ) f ( b ( n ) )}{{\sum }_{n} f ( b ( n ) )}$$

where f(b(n)) is the histogram of the angle of the autocorrelation;
N is the number of bins; and
b(n) are the bin centers of the histogram of the autocorrelation.

The method may further include generating a second estimate of the at least one characteristic of the histogram (step 68). By way of example, the second estimate (for example, a final estimate) may be generated using the following equation:

$$FinalEstimate = \frac{{\sum }_{n = N 1}^{n = N 2} b ( n ) f ( b ( n ) )}{{\sum }_{n = N 1}^{n = N 2} f ( b ( n ) )}$$

where f(b(n)) is the histogram of the angle of the autocorrelation;

N is the number of bins;

N1 is a first bin center and N2 is a second bin center; and

b(n) are the bin centers of the histogram of the autocorrelation.

The method may further include estimating the frequency error based on the second estimate (step 70). As explained above with respect to step 56 of FIG. 4, the frequency error may be computed by computing an estimated frequency from the mean or mode of the histogram by using the following equation:

fₑₛₜ=fₛ*(final estimate of a characteristic of the histogram)/(2π*N_{fft}),

where fₑₛₜ is the final frequency estimate;

fₛ is the frequency of the sample clock synthesized from a local oscillator incorporated in the OFDM receiver of FIG. 1, for example;

final estimate of a characteristic of the histogram may be an estimate of the mean or mode of the phase histogram; and

N_{fft} is equal to T_{fft}*fₛ, and where f_{Δ} is the frequency spacing between the OFDM sub-carriers, T_{fft} is approximately 1/f_{Δ}, and fₛ is the sampling rate of the OFDM complex valued sample stream (thus N_{fft} is the size of the fast fourier transform for the OFDM complex valued sample stream).

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for estimating a frequency error of a sample stream comprising a plurality of symbols, comprising:
receiving the sample stream; and
estimating a frequency error from a phase distribution or a linear function of the phase distribution of an autocorrelation generated by autocorrelating a cyclic prefix of each of the plurality of symbols with a corresponding information part of each of the plurality of symbols over at least two frequencies to generate the phase distribution of the autocorrelation.

2. The method of claim 1, wherein the sample stream is an orthogonal-frequency division multiplexed sample stream.

3. The method of claim 1, wherein the autocorrelation is generated over the at least two frequencies by breaking the autocorrelation computation into frequency bins.

4. The method of claim 3 further comprising computing an average of the autocorrelation to generate an estimate of the frequency error.

5. A method for estimating frequency error of a sample stream comprising a plurality of symbols, comprising:
receiving a sample stream;
simultaneously autocorrelating a cyclic prefix of each of the plurality of symbols with a corresponding portion of an information part of each of the plurality of symbols over at least two frequencies to generate a phase distribution of the autocorrelation;
generating a histogram of the phase distribution; and
estimating the frequency error based on at least one characteristic of the histogram.

6. The method of claim 5, wherein the sample stream is an orthogonal-frequency division multiplexed sample stream.

7. The method of claim 5, wherein the autocorrelation is simultaneously generated over the at least two frequencies by breaking the autocorrelation computation into at least two frequency bins.

8. The method of claim 5, wherein the at least one characteristic of the histogram comprises at least one of a mean, mode, and a mean over a subset of bin centers.

9. The method of claim 5 further comprising computing an average of the autocorrelation to generate an estimate of the frequency error.

10. A method for estimating frequency error of a sample stream comprising a plurality of symbols, comprising:
receiving a sample stream;
simultaneously autocorrelating a cyclic prefix of each of the plurality of symbols with a corresponding portion of an information part of each of the plurality of symbols over at least two frequencies to generate a phase distribution of the autocorrelation;
generating a histogram of the phase distribution;
generating a first estimate of at least one characteristic of the histogram;
generating a second estimate of the at least one characteristic of the histogram based on at least the first estimate; and
estimating the frequency error based on the second estimate.

11. The method of claim 10, wherein the sample stream is an orthogonal-frequency division multiplexed sample stream.

12. The method of claim 11, wherein the autocorrelation is simultaneously generated over the at least two frequencies by breaking the autocorrelation computation into at least two frequency bins.

13. The method of claim 11, wherein the at least one characteristic of the histogram comprises at least one of a mean, mode, and a mean over a subset of bin centers.

14. The method of claim 11 further comprising computing an average of the autocorrelation to generate an estimate of the frequency error.

15. A system for estimating frequency error of a sample stream comprising a plurality of symbols, the system comprising:
an antenna for receiving a sample stream;
a processing engine for:
simultaneously autocorrelating a cyclic prefix of each of the plurality of symbols with a corresponding portion of an information part of each of the plurality of symbols over at least two frequencies to generate a phase distribution of the autocorrelation;
generating a histogram of the phase distribution;
generating a first estimate of at least one characteristic of the histogram;
generating a second estimate of the at least one characteristic of the histogram based on at least the first estimate; and
estimating the frequency error based on the second estimate.

16. The system of claim 15, wherein the sample stream is an orthogonal-frequency division multiplexed sample stream.

17. The system of claim 15, wherein the autocorrelation is simultaneously generated over the at least two frequencies by breaking the autocorrelation computation into at least two frequency bins.

18. The system of claim 15, wherein the at least one characteristic of the histogram comprises at least one of a mean, mode, and a mean over a subset of bin centers.

19. The system of claim 15, wherein the processing engine further computes an average of the autocorrelation to generate an estimate of the frequency error.
